(19) United States
(12) Patent Application Publication
(10) Pub. No.: US 2012/0027078 A1
(43) Pub. Date: Feb. 2, 2012

(54) INFORMATION PROCESSING APPARATUS AND INFORMATION PROCESSING METHOD

(75) Inventor: Takahiro TAKIMOTO, Sayama-shi (JP)

(73) Assignee: KABUSHIKI KAISHA TOSHIBA, Tokyo (JP)

(21) Appl. No.: 13/098,187

(22) Filed: Apr. 29, 2011

(30) Foreign Application Priority Data
Jul. 28, 2010 (JP) 2010-169632

(51) Int. Cl. H04N 7/26

(52) U.S. Cl. 375/240.02; 375/240.24; 375/E07.19; 375/E07.181

(57) ABSTRACT

According to one embodiment, an information processing apparatus includes a converter, a detector and a first filter processing module. The converter is configured to produce a plurality of decoded pictures at least by decoding and converting a motion picture stream, the motion picture stream generated by encoding a plurality of pixels on a block-by-block basis into pictures. The detector is configured to detect a reference picture from the plurality of decoded pictures, the reference picture comprising a picture that is referred to by another picture of the plurality of decoded pictures at decoding. The first filter processing module is configured to perform image quality improvement processing on the reference picture detected by the detector and not to perform the image quality improvement processing on pictures from the plurality of decoded pictures which are not reference pictures.

### CROSS REFERENCE TO RELATED APPLICATION(S)

This application is based upon and claims the benefit of priority from Japanese Patent Application No. 2010-169632 filed on Jul. 28, 2010, the entire contents of which are incorporated herein by reference.

### FIELD

Embodiments described herein relate generally to an information processing apparatus and an information processing method which perform post-filter processing on video data after decoding it.

### BACKGROUND

In recent years, personal computers having an AV (audio-video) function that is similar to the AV function of DVD (digital versatile disc) players and TV receivers have been developed.

Such personal computers employ a software decoder which decodes a compressed motion picture stream by software. The use of the software decoder makes it possible to decode an encoded motion picture stream with a processor (CPU) without the need for incorporating dedicated hardware.

H.264/AVC (advanced video coding) has come to be used as a motion picture encoding technique. H.264/AVC is an encoding technique, which is higher in efficiency than encoding techniques such as MPEG2 and MPEG4 and is used for coding a high-resolution image such as an image of HD (high definition). Therefore, each of encoding and decoding that comply with the H.264/AVC standard requires a larger amount of processing than encoding techniques such as MPEG2 and MPEG4.

Therefore, in personal computers which are designed so as to decode, by software, a motion picture stream that was encoded according to the H.264/AVC standard, whereas they can play back a high-resolution image, a delay may occur in decoding itself to disable smooth motion picture stream playback when the system load becomes unduly heavy. Similar standards being drafted following the H.264/AVC standard are associated with the same situation. Among various kinds of processing, filter processing requires a large amount of processing and hence may cause a delay in decoding in processing a high-resolution image.

One typical technique relating to the encoding technique is deblocking filter processing which is part of decoding, and post-filter processing is known as processing which is performed after deblocking filter processing. At present, it is necessary to perform deblocking filter processing and post-filter processing efficiently.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary perspective view showing an appearance of a computer according to an embodiment;

FIG. 2 is an exemplary block diagram showing a system configuration of the computer shown in FIG. 1;

FIG. 3 is an exemplary block diagram showing a functional configuration of a video playback application program used in the computer shown in FIG. 1;

FIG. 4 is an exemplary block diagram showing a functional configuration that is realized in the system configuration shown in FIG. 2;

FIG. 5 is an exemplary block diagram showing a configuration of a software decoder (motion picture decoding device) realized by the video playback application program shown in FIG. 3;

FIG. 6 is an exemplary conception view showing a relationship between reference pictures and non-reference pictures contained in a motion picture stream and Filter ON/OFF;

FIG. 7 is an exemplary flowchart showing a procedure of a decoding process which is executed by the video playback application program shown in FIG. 3; and

FIG. 8 is an exemplar block diagram showing a motion picture decoding device according to the embodiment.

### DETAILED DESCRIPTION

In general, according to one embodiment, an information processing apparatus includes a converter, a detector and a first filter processing module. The converter is configured to produce a plurality of decoded pictures at least by decoding and converting a motion picture stream, the motion picture stream generated by encoding a plurality of pixels on a block-by-block basis into pictures. The detector is configured to detect a reference picture from the plurality of decoded pictures, the reference picture comprising a picture that is referred to by another picture of the plurality of decoded pictures at decoding. The first filter processing module is configured to perform image quality improvement processing on the reference picture detected by the detector and not to perform the image quality improvement processing on pictures from the plurality of decoded pictures which are not reference pictures.

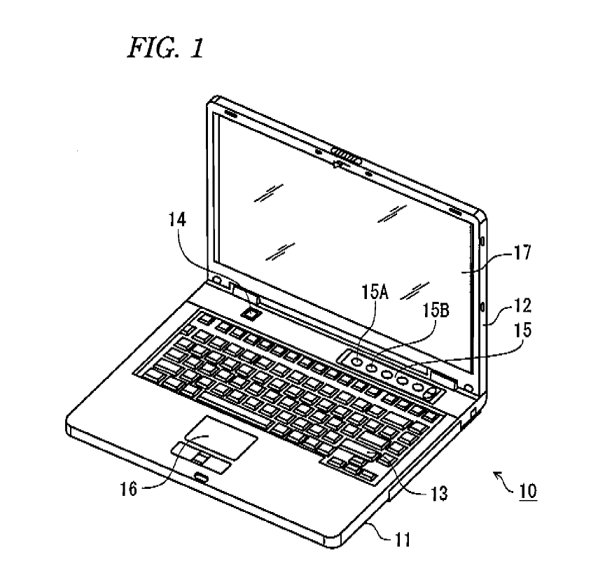

An exemplary embodiment will be hereinafter described with reference to FIGS. 1-7.

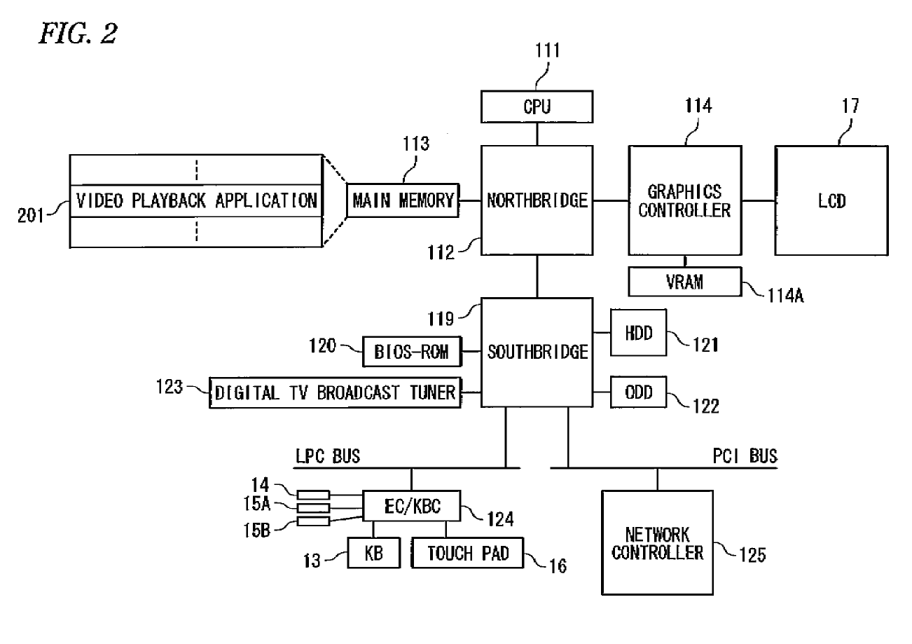

First, the configuration of a notebook personal computer 10 as an information processing apparatus according to the embodiment will be described with reference to FIGS. 1 and 2. Alternatively, the embodiment may be implemented as a desk-top personal computer.

FIG. 1 is a front perspective view of the notebook personal computer 10 in a state that a display unit 12 is opened. The computer 10 is composed of a main unit 11 and the display unit 12. An LCD (liquid crystal display) 17 as a display device is incorporated in the display unit 12 in such a manner that the display screen of the LCD 17 occupies most of the front side of the display unit 12.

The display unit 12 is attached to the main unit 11 so as to be rotatable between an open position and a closed position. The main unit 11 has a thin, box-shaped case, and the top surface of the case is provided with a keyboard 13, a power button 14 for powering on/off the computer 10, an operating panel 15, a touch pad 16, etc.

The operating panel 15 is an input device for inputting an event corresponding to a button pressed, and is provided with multiple buttons for activating respective functions. The buttons include a TV activation button 15A and a DVD activation button 15B. The TV activation button 15A is a button for activating a TV function for playing back/recording data of a broadcast program such as a digital TV broadcast program. When the TV activation button 15A is pressed by the user, an application program for execution of the TV function is activated automatically. The DVD activation button 15B is a button for playing back a video content recorded in a DVD. When the DVD activation button 15B is pressed by the user, an application program for playback of a video content is activated automatically.

Next, the system configuration of the computer 10 will be described with reference to FIG. 2. As shown in FIG. 2, the personal computer 10 includes a CPU 111, a northbridge 112, a main memory 113, a graphics controller 114, a southbridge 119, a BIOS-ROM 120, a hard disk drive (HDD) 121, an optical disc drive (ODD) 122, a digital TV broadcast tuner 123, an embedded controller/keyboard controller IC (EC/KBC) 124, a network controller 125, etc.

The CPU 111, which is a processor provided to control operations of the computer 10, runs an operating system (OS) and various application programs such as a video playback application program 201 when they are loaded into the main memory 113 from the HDD 121.

The CPU 111 has a cache memory. Parts of various programs being run and related data are stored in the cache memory and can be used continuously without the need for referring to them by accessing the main memory 113 or writing detailed changes to the main memory 113.

The video playback application program 201 is software for decoding and playing back compressed motion picture data, and is a software decoder that complies with the H.264/AVC standard. The video playback application program 201 has a function for decoding a motion picture stream (of a digital TV broadcast program received by the digital TV broadcast tuner 123, a video content of the HD (high-definition) standard read from the ODD 122, or the like) that was encoded according to a encoding method that is defined in the H.264/AVC standard.

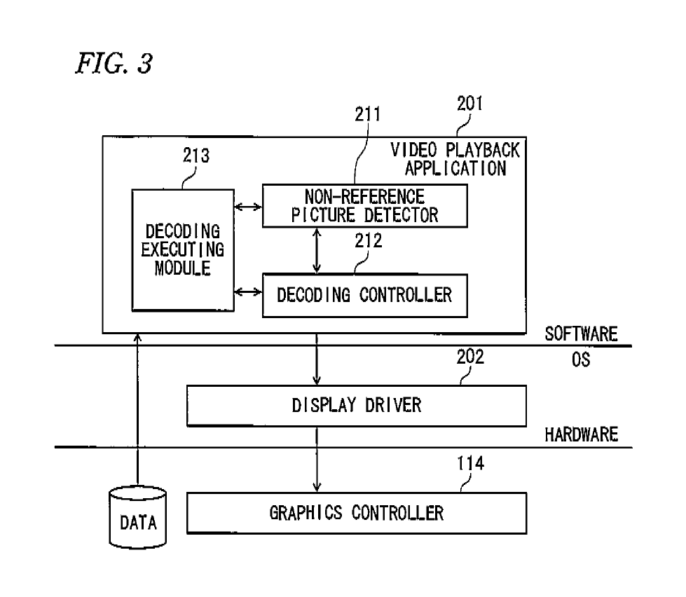

As shown in FIG. 3, the video playback application program 201 has a non-reference picture detector 211, a decoding controller 212, and a decoding executing module 213.

The decoding executing module 213 is a decoder which performs decoding which is defined in the H.264/AVC standard. The non-reference picture detector 211 is a module of detecting a non-reference picture (described later) in decoding. For example, the non-reference picture detector 211 detects a non-reference picture by inquiring of the decoding executing module 213 about a current status of a decoding operation that is being performed.

The decoding controller 212 controls a decoding operation that is performed by the decoding executing module 213, according to a detection result of the non-reference picture detector 211 (i.e., whether the picture is a non-reference picture or not).

More specifically, the decoding controller 212 not only controls a decoding operation to be performed on a non-reference picture by the decoding executing module 213 as decoding defined in the H.264/AVC standard but also controls later post-filter processing that is performed by the CPU 111 so that when predetermined processing was performed on a non-reference picture by the decoding executing module 213, the predetermined processing is not performed on the non-reference picture (i.e., so that the predetermined processing is performed only on reference pictures). To this end, the decoding controller 212 outputs additional information via the decoding executing module 213 separately from an output image which is a result of the decoding operation.

Motion picture data that have been decoded by the video playback application program 201 are sequentially written to the video memory 114A of the graphics controller 114 via a display driver 202, and thereby displayed on the LCD 17. The display driver 202 is software for controlling the graphics controller 114.

The CPU 111 also runs a system BIOS (basic input/output system) which is stored in the BIOS-ROM 120. The system BIOS is a hardware control program.

The northbridge 112 is a bridge device for connecting a local bus of the CPU 111 to the southbridge 119. The northbridge 112 incorporates a memory controller for access-controlling the main memory 113. The northbridge 112 also has a function of performing a communication with the graphics controller 114 via an AGP (accelerated graphics port) bus or the like.

The graphics controller 114 is a display controller for controlling the LCD 117 which is used as a display monitor of the computer 10. The graphics controller 114 generates a display signal to be supplied to the LCD 117 on the basis of image data that is written in a video memory (VRAM) 114A.

The southbridge 119 controls the individual devices on an LPC (low pin count) bus and the individual devices on a PCI (peripheral component interconnect) bus. The southbridge 119 incorporates an IDE (integrated drive electronics) controller for controlling the HDD 121 and the ODD 122. The southbridge 119 also has a function of controlling the digital TV broadcast tuner 123 and a function of access-controlling the BIOS-ROM 120.

The HDD 121 is a storage device for storing various kinds of software and data. The ODD 122 is a drive module for driving a storage medium such as a DVD in which a video content is stored. The digital TV broadcast tuner 123 is a receiving device for receiving data of an external broadcast program such as a digital TV broadcast program.

The EC/KBC 124 is a one-chip microcomputer in which an embedded controller for power management and a keyboard controller for controlling the keyboard 13 and the touch pad 16 are integrated together. The EC/KBC 124 has a function of powering on/off the computer 10 in response to operation of the power button 14 by the user. Furthermore, the EC/KBC 124 can power on the computer 10 in response to operation of the TV activation button 15A or the DVD activation button 15B by the user. The network controller 125 is a communication device for performing a communication with an external network such as the Internet.

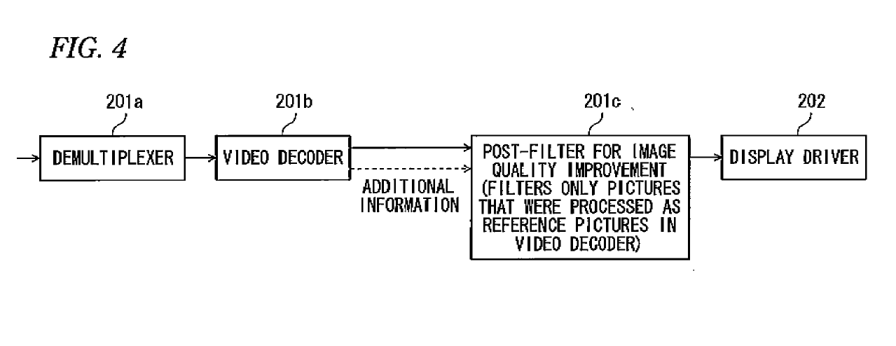

Next, a functional configuration that is realized by the video playback application program 201 in the above-described system configuration of the computer 10 will be described with reference to FIG. 4. A demultiplexer 201a takes next-stage input streams of audio, an image, subtitles, etc. out of a multiplexed stream and passes the image input stream to a video decoder 201b (next stage). The video decoder 201b passes an output image and additional information (mentioned above; indicated by a broken line) to a post-filter 201c. The post-filter 201c passes an output image generated by post-filter processing to the display driver 202.

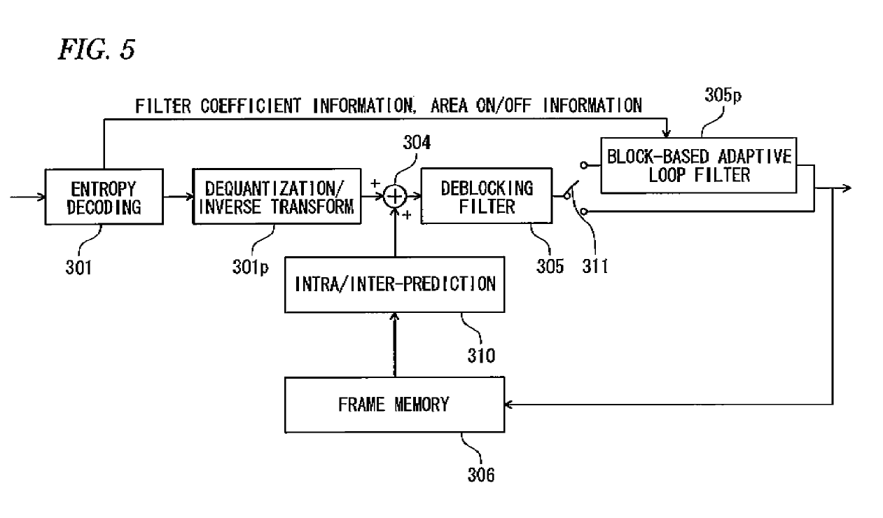

Next, a functional configuration of a motion picture decoding device which is a software decoder realized by the video playback application program 201 will be described with reference to FIG. 5. This motion picture decoding device corresponds to the video decoder 201b shown in FIG. 4.

The decoding executing module 213 of the video playback application program 201 complies with HEVC whose standardization is currently being discussed. As shown in FIG. 5, the decoding executing module 213 includes an entropy decoding module 301, a dequantization/inverse transform module 301p (a cascade connection of a dequantization module and an inverse DCT (discrete cosine transform) module (not shown)), an adder 304, a deblocking filter module 305, a block-based adaptive loop filter 305p, a frame memory 306, an intra/inter-prediction module 310, and a mode changeover switch module 311. The term “DCT” is used here though it has a different meaning than in related-art cases because the orthogonal transform of H.264 employs integer precision.

Each picture is coded in units of a 16×16 macroblock, for example. One of an intra-frame coding mode (intra-coding mode) and a motion compensation inter-frame predictive coding mode (inter-coding mode) is selected for each macroblock.

In the motion compensation inter-frame predictive coding mode, a motion compensation prediction signal corresponding to a coding subject picture is generated in units of a predetermined size by estimating a motion from an already coded picture. A prediction error signal obtained by subtracting the motion compensation prediction signal from the coding subject picture is coded by orthogonal transform (DCT), quantization, and entropy coding. In the intra-frame coding mode, a prediction signal is generated from a coding subject picture and coded by orthogonal transform (DCT), quantization, and entropy coding.

To make the compression ratio larger than in the related-art standards, a codec that complies with the H.264/AVC standard employ the following and other techniques:

(1) Motion compensation of higher pixel precision (¼ pixel precision) than in the MPEG standards

(2) Intra-frame prediction for performing intra-frame coding efficiently

(3) Deblocking filter for lowering the degree of block distortion

(4) Integer DCT performed in units of 4×4 pixels

(5) Multi-reference frame capable of using, as reference pictures, multiple pictures at an arbitrary position

(6) Weighted prediction

How the software decoder of FIG. 5 operates will be described below.

First, a compressed motion picture stream is input to the entropy decoding module 301 which performs entropy decoding (variable-length decoding). The compressed motion picture stream contains, in addition to coded image information, motion vector information that was used in motion compensation inter-frame predictive coding (inter-prediction coding), intra-frame prediction information that was used in intra-frame prediction coding (intra-prediction coding), mode information indicating a prediction mode (inter-prediction coding or intra-prediction coding), etc.

A decoding operation is performed in units of 16×16 macroblock, for example. The entropy decoding module 301 separates the quantization DCT coefficients, motion vector information (motion vector difference information), intra-frame prediction information, and mode information from the motion picture stream by performing entropy decoding (variable-length decoding) on it. For example, each of macroblocks of a decoding subject picture is entropy-decoded in units of a block of 4×4 pixels (or 8×8 pixels) and each block is converted into 4×4 (or 8×8) quantized DCT coefficients. The following description will be directed to a case that each block consists of 4×4 pixels.

The intra-frame prediction information is supplied to the intra/inter-prediction module 310. The mode information (described later) is supplied to the mode changeover switch 311. The block-based adaptive loop filter module 305p performs BALF (block-based adaptive loop filter) processing (refer to T. Chujoh, G. Yasuda, N. Wada, T. Watanabe, and T. Yamakage, “Block-based Adaptive Loop Filter,” ITU-T SG16 Q.6, VCEG-AI18, Berlin, July 2008).

The 4×4 quantized DCT coefficients of each decoding subject block are converted into 4×4 DCT coefficients (orthogonal transform coefficients) by dequantization processing which is performed by the dequantization module. The 4×4 DCT coefficients, which are pieces of frequency-domain information, are converted into 4×4 pixel values by inverse integer DCT (inverse orthogonal transform) processing which is performed by the inverse DCT module. The 4×4 pixel values are prediction error signals corresponding to the decoding subject block. The prediction error signal is supplied to the adder 304, where it is added with a prediction signal (motion compensation inter-frame prediction signal or intra-frame prediction signal) corresponding to the decoding subject block. The 4×4 pixel values corresponding to the decoding subject block are thus decoded.

In the intra-prediction mode, an intra-frame prediction signal supplied from the intra/inter-prediction module 310 is added to the prediction error signal. In the inter-prediction mode, a motion compensation inter-frame prediction signal (not shown) is added to the prediction error signal.

In this manner, an operation of decoding a decoding subject picture by adding a prediction signal (motion compensation inter-frame prediction signal or intra-frame prediction signal) to a prediction error signal corresponding to the decoding subject picture is performed in units of a block having a predetermined size.

Each decoded picture is subjected to deblocking filter processing which is performed by the deblocking filter module 305 and a resulting picture is stored in the frame memory 306. The deblocking filter module 305 performs the deblocking filter processing for reducing block noise on each decoded picture in units of a 4×4 block, for example. The deblocking filter processing prevents an event that block distortion is included in a reference picture and thereby transmitted so as to be included in a decoded image. The deblocking filter processing is performed adaptively so that strong filtering is performed on a portion where block distortion is prone to occur and weak filtering is performed on a portion where block distortion is not prone to occur. The deblocking filter processing is realized by loop filter processing.

Each picture that has been generated by deblocking filter processing is read from the frame memory 306 as an output image frame (or output image field). Each picture (reference picture) to be used as a reference image for motion compensation inter-frame prediction is stored in the frame memory 306 for a predetermined time. In the motion compensation inter-frame prediction coding of the H.264/AVC standard, multiple pictures can be used as reference pictures. Therefore, the frame memory 306 is provided with multiple frame memories for storing multiple images (pictures).

The intra/inter-prediction module 310 is a module for generating, from a decoding subject picture, an intra-frame prediction signal of a decoding subject block included in the decoding subject picture. The intra/inter-prediction module 310 generates an intra-frame prediction signal using pixel values of other, already decoded blocks existing in the vicinities of the decoding subject block in the same picture as the decoding subject block by performing intra-picture prediction processing according to the above-mentioned intra-frame prediction information. The intra-frame prediction (intra-prediction) is a technique for increasing a compression ratio by utilizing pixel correlation between blocks. In the intra-frame prediction, one of four prediction modes that are a vertical prediction mode (prediction mode 0), a horizontal prediction mode (prediction mode 1), an average prediction mode (prediction mode 3), and a plane prediction mode (prediction mode 4) is selected in units of an intra-frame prediction block (e.g., 16×16 pixels).

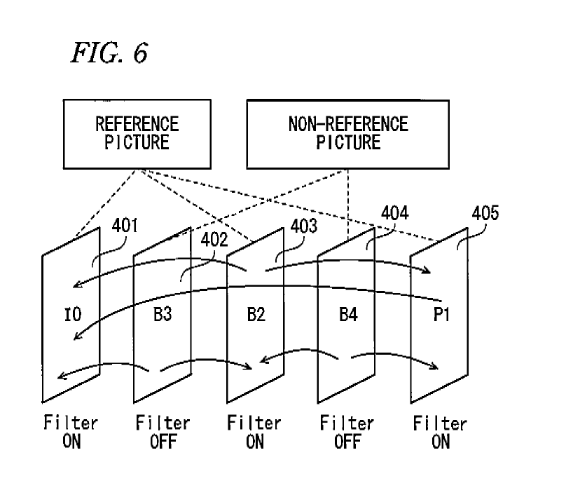

Next, reference pictures and non-reference pictures contained in a motion picture stream will be described with reference to FIG. 6.

Various pictures contained in a motion picture stream to be decoded are input to the software decoder (see FIG. 5) in predetermined order and subjected to such processing as motion compensation inter-frame prediction and intra-frame prediction. A description will be made of an example that an I picture 401, a B picture 402, a B picture 403, a B picture 404, and a P picture 405 are input to the software decoder in this order and processed there.

The P picture is a picture on which motion compensation inter-frame prediction is performed by referring to one picture. The B picture is a picture on which motion compensation inter-frame prediction is performed by referring to two pictures. The I picture is a picture on which intra-frame prediction is performed independently inside the picture, that is, without referring to any other picture.

As shown in FIG. 6, whereas the picture 401 does not refer to any picture, it is referred to from the pictures 402, 403 and 405. Whereas the picture 403 refers to the pictures 401 and 405, the picture 403 is referred to from the pictures 402 and 404. Whereas the picture 405 refers to the picture 401, the picture 405 is referred to from the pictures 403 and 404. The pictures 401, 403, and 405 which are referred to from other pictures in the inter-picture prediction are reference pictures.

On the other hand, as shown in FIG. 6, whereas the picture 402 refers to the pictures 401 and 403, the picture 402 is not referred to from any other picture. Whereas the picture 404 refers to the pictures 403 and 405, the picture 404 is not referred to from any other picture. The pictures 402 and 404 which are not referred to from any other picture in the inter-picture prediction are non-reference pictures.

The mode information indicating whether the picture is a reference picture or a non-reference picture is supplied to the mode changeover switch 311. If the picture is a reference picture, it is further processed in the block-based adaptive loop filter module 305p.

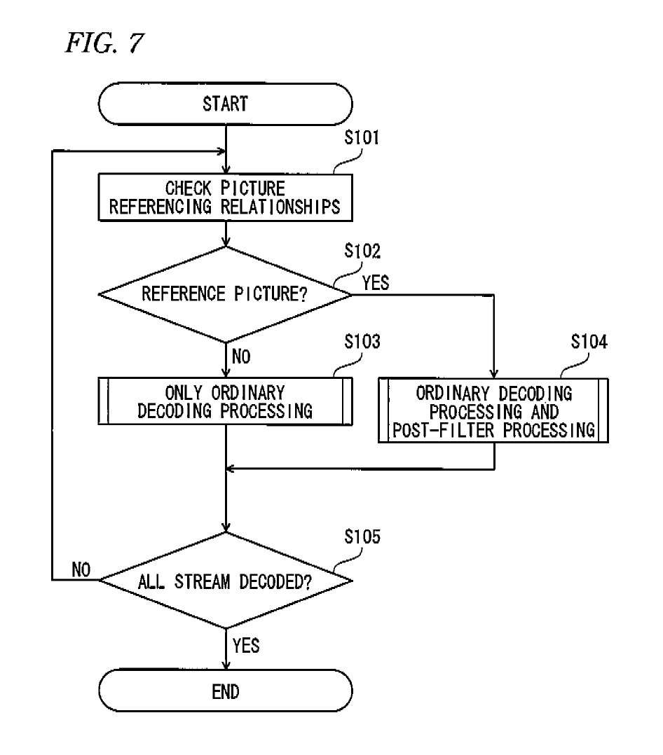

The procedure of a decoding process which is executed by the video playback application program 201 will be described below with reference to a flowchart of FIG. 7.

At step S101, the video playback application program 201 detects a reference picture by checking a picture referencing relationships. This is done regularly during execution of a decoding operation.

At step S102, the video playback application program 201 determines whether the picture being processed is a reference picture or not. If the picture being processed is not a reference picture (S102: no), at step S103 the video playback application program 201 selects the ordinary decoding as decoding processing to be performed by the CPU 111 and the CPU 111 performs the series of pieces of decoding processing described above with reference to FIG. 5.

On the other hand, if the picture being processed is a reference picture (S102: yes), the video playback application program 201 selects, as decoding processing to be performed by the CPU 111, at step S104 processing in which post-filter processing is performed after the above-described ordinary decoding processing (more specifically, the deblocking filter processing) early enough for data to remain in the cache memory is selected and the CPU 111 performs that processing.

Steps S101 to S104 shown in FIG. 5 are executed repeatedly until the entire motion picture stream is decoded (step S105). Examples of the post-filter processing are color adjustment and noise elimination.

As described above, the embodiment makes it possible to perform post-filter processing after deblocking filter processing which is part of a decoding operation of the computer 10. As a result, the cache memory can be used efficiently in accessing image data and hence increase in the performance of a decoding operation is expected.

Since the whole of the above-described decoding control is realized by the computer program, the same advantages as obtained by the embodiment can be realized by merely introducing the computer program into an ordinary computer via a computer-readable storage medium.

The software decoder according to the embodiment can also be applied to not only personal computers but also PDAs, cell phones, etc.

### (Coding Device)

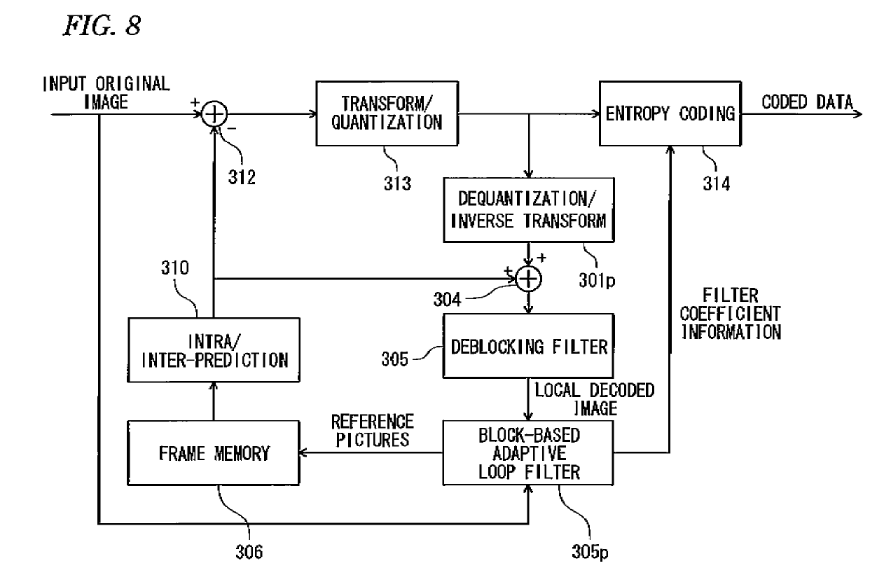

For reference, a coding device relating to the embodiment will be described below with reference to FIG. 8.

FIG. 8 is a block diagram of a motion picture coding device which is necessary in generating coded data to become input data in FIG. 5. This motion picture coding device is used in broadcasting stations etc. The motion picture coding device is configured by adding an adder 312, a transform/quantization module 313, and an entropy coding module 314 to the components of the motion picture decoding device of FIG. 5 (except for the entropy decoding module 301).

Coded data generated by the motion picture coding device of FIG. 8 contains, as syntax, filter coefficients to be used in the block-based adaptive loop filter module 305p shown in FIG. 5, information of blocks to which loop filter adaptation processing is to be applied in each slice, and data that are necessary for filter processing.

When receiving such coded data, the motion picture decoding device according to the embodiment performs entropy decoding (variable-length decoding) and supplies the above-mentioned data that are necessary for filter processing to the block-based adaptive loop filter module 305p. Receiving the filter data, the block-based adaptive loop filter module 305p performs or does not perform filter processing on an input frame depending on its picture type, that is, whether or not the mode changeover switch 311 passes the input frame. The block-based adaptive loop filter module 305p performs filter processing if an input image is a reference picture, and does not perform filter processing if the input image is a non-reference picture.

In some related-art techniques, on the decoder side filter processing is necessarily performed on filtering subject pictures determined on the encoder side. In contrast, in the embodiment, non-reference pictures are not subjected to the filter processing. In the related-art techniques, the filter processing requires a large amount of processing and hence a delay may be caused when a high-resolution image is decoded.

The embodiment provides an advantage that it can suppress delay in decoding while preventing image quality degradation because non-reference pictures are not subjected to filter processing.

The embodiment can suppress delay in decoding while preventing image quality degradation because, as described in the following important features, the block-based adaptive loop filter module is applied to reference pictures and is not applied to non-reference pictures in the motion picture decoding device.

(1) The embodiment relates to a loop filter which is used in the next-generation motion picture coding standard.

(2) In the motion picture decoding method, to suppress delay in decoding while preventing image quality degradation, filter processing is performed on reference pictures and is not performed on non-reference pictures.

(3) Whereas in coding filter processing is performed on both of reference pictures and non-reference pictures, in decoding a user can decide on whether filter processing should be performed on pictures of all types or on only reference pictures.

(4) The embodiment is directed to a motion picture coding/decoding method in which filter coefficients that are set on the coding side are transmitted to the decoding side and used there.

The embodiment is not limited to the above embodiment and can be practiced so as to be modified in various manners without departing from the spirit and scope of the invention. For example, although the embodiment refrains from performing filter processing only on non-reference pictures, the filter type or the like may be changed only for non-reference pictures to reduce the amount of processing of the filter processing. More specifically, a one-dimensional filter may be used for non-reference pictures whereas a two-dimensional filter is used for reference pictures. Or a filter the number of whose taps is smaller than a filter for reference pictures may be used for non-reference pictures.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and method, described herein may be made without departing from the spirit of the invention. The accompanying claims and their equivalents are intended to cover such forms or modifications as would fall within the scope and spirit of the invention.

What is claimed is:

1. An information processing apparatus comprising:
a converter configured to produce a plurality of decoded pictures at least by decoding and converting a motion picture stream, the motion picture stream generated by encoding a plurality of pixels on a block-by-block basis into pictures;
a detector configured to detect a reference picture from the plurality of decoded pictures, the reference picture comprising a picture that is referred to by another picture of the plurality of decoded pictures at decoding; and
a first filter processor configured to perform image quality improvement processing on the reference picture detected by the detector and not to perform the image quality improvement processing on pictures from the plurality of decoded pictures which are not reference pictures.

2. The apparatus of claim 1, wherein the image quality improvement processing comprises block-based adaptive loop filter processing.

3. The apparatus of claim 1, further comprising:
a second filter processor configured to perform strong filtering on a portion of a picture where block distortion is prone to occur and to perform weak filtering on a portion of a picture where block distortion is not prone to occur.

4. The apparatus of claim 3, wherein the second filter processor's performance of strong filtering and weak filtering comprises less processing than the first filter processor's performance of image quality improvement processing.

5. The apparatus of claim 1, wherein the detector comprises a decoding controller.

6. The apparatus of claim 1, wherein the apparatus is located in a notebook computer.

7. The apparatus of claim 1, wherein converting comprises generating quantized DCT coefficients.

8. The apparatus of claim 1, wherein decoding comprises entropy decoding.

9. The apparatus of claim 1, wherein the reference picture comprises either a P or a B-picture.

10. A method for processing pictures comprising:
generating a plurality of decoded pictures at least by decoding and converting a motion picture stream, the motion picture stream generated by encoding a plurality of pixels on a block-by-block basis into pictures;
detecting a reference picture from the plurality of decoded pictures, the reference picture comprising a picture that is referred to by another picture of the plurality of decoded pictures at decoding; and
performing image quality improvement processing on the detected reference picture and not performing the image quality improvement processing on pictures from the plurality of decoded pictures which are not reference pictures.

11. The method of claim 10, wherein the image quality improvement processing comprises block-based adaptive loop filter processing.

12. The method of claim 10, further comprising:
performing strong filtering on a portion of a picture where block distortion is prone to occur; and
performing weak filtering on a portion of a picture where block distortion is not prone to occur.

13. The method of claim 12, wherein performing strong filtering and weak filtering comprises less processing than the performance of image quality improvement processing.

14. The method of claim 10, wherein the reference picture comprises either a P or a B-picture.

15. The method of claim 10, wherein decoding comprises entropy decoding.

16. The method of claim 10, wherein converting comprises generating quantized DCT coefficients.

17. The method of claim 10, wherein the method is implemented on a notebook computer.
